(19) United States
(12) Patent Application Publication
(10) Pub. No.: US 2009/0249056 A1
(43) Pub. Date: Oct. 1, 2009

(54) APPARATUS AND METHOD FOR RETRIEVING NON-VOLATILE ITEMS IN PORTABLE TERMINAL

(75) Inventor: Dong-Jin SEO, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/415,298

(22) Filed: Mar. 31, 2009

(30) Foreign Application Priority Data
Apr. 1, 2008 (KR) 10-2008-0030511

(51) Int. Cl. G06F 15/177; G06F 12/00; G06F 12/02

(52) U.S. Cl. 713/2; 707/205; 711/104; 340/825

(57) ABSTRACT

Provided are an apparatus and a method for reducing a booting time by separately storing Non-Volatile (NV) items for at least one frequency band supported by a portable terminal in a non-volatile memory, and retrieving the stored NV items from a memory to which the stored NV items are copied whenever a booting process is performed. The apparatus includes a memory and a controller. The memory stores the file system including NV items including parameters used for driving and initializing a portable terminal. The controller generates and stores NV items representing transmission/reception performance values for the at least one frequency band supported by the portable terminal from the parameters, and copies the stored NV items during a booting process of the portable terminal.

### PRIORITY

This application claims the benefit under 35 U.S.C. § 119(a) of a Korean patent application filed in the Korean Intellectual Property Office on Apr. 1, 2008 and assigned Serial No. 10-2008-0030511, the entire disclosure of which is hereby incorporated by reference.

### BACKGROUND OF THE INVENTION

1. Field of the Invention

The present invention relates to an apparatus and a method for retrieving Non-Volatile (NV) items in a portable terminal. More particularly, the present invention relates to an apparatus and a method for shortening a booting time by separately collecting and storing NV items for frequency bands supported by a portable terminal, and retrieving the stored NV items whenever a booting process is performed.

2. Description of the Related Art

A portable terminal may be a wireless communication apparatus that is small enough to be carried and allows for communication or data to be exchanged with a counterpart from any location within a coverage area of a base station. As our society becomes increasingly information-oriented, the portable terminal is becoming increasingly important and ubiquitous.

The portable terminal defines and stores parameters required for operating and initializing the portable terminal in a memory. For example, the portable terminal stores unique information of the portable terminal and set data of respective units.

Since the parameters and unique information defined and stored in the memory are data that should be maintained even when power supplied to the portable terminal is discontinued, the parameters and unique information are permanently stored in a non-volatile memory such as a flash memory. The parameters and unique information are referred to as Non-Volatile (NV) items. A portion of the NV items are copied from the non-volatile memory to a specific region (NV table) in Random Access Memory (RAM) and are accessed during a booting process of the portable terminal, thereby allowing the portable terminal to operate normally. More particularly, since Radio Frequency (RF) performance values cannot be collectively applied to a unique software binary, NV items are used in general.

The NV items are stored in a file system inside a flash memory. In general, accessing data from a file system takes about ten times longer than directly accessing data from memory.

FIG. 1 is a diagram illustrating a process of using NV items in a conventional portable terminal.

Referring to FIG. 1, the portable terminal performs an NV item calibration process 100 of storing NV item values of the portable terminal in an NV memory, and an NV item retrieve process 110 of retrieving and using the NV items stored in the NV memory during a booting process of the portable terminal.

It is assumed that the portable terminal stores 1000 NV items (NV data) inside a file system as illustrated in FIG. 1 and generates an RF table that comprises 500 NV items of the 1000 NV items. The 500 NV items in the RF table correspond to frequency bands supported by the portable terminal. Here, the RF table includes 250 NV items related to Global System for Mobile communications (GSM) and 250 NV items related to Wideband Code Division Multiple Access (WCDMA).

The portable terminal performs the NV item calibration process 100 by storing the 1000 NV items in the file system in the NV memory. Here, the NV items are unique parameter information required for the operation of the portable terminal, and include NV items corresponding to transmission/reception performance values for each frequency band supported by the portable terminal.

The portable terminal accesses the file system when performing the retrieve process 110 during the booting of the portable terminal, checks the 1000 NV items one by one to determine which of the 1000 NV items correspond to frequency bands supported by the portable terminal, and generates the RF table using the 500 NV items determined to correspond to frequency bands supported by the portable terminal. The RF table of the 500 NV items is stored in RAM and includes the transmission/reception performance values for each frequency band supported by the portable terminal. In other words, the portable terminal accesses the file system in which the 1 to 1000th NV items are stored and retrieves and uses 500 NV items (250 items related to GSM and 250 items related to WCDMA) that are used by the portable terminal. It takes about 5 to 6 seconds to retrieve the NV items from the file system, which is about ten times longer than it would take to directly retrieve the NV items from memory.

Since the above-described method of using NV items of a portable terminal includes storing a unique characteristic value after the NV item calibration process in a file system and accesses the file system whenever a retrieving process is performed, when the portable terminal uses unique NV items during wireless communication, a booting time is lengthened.

In addition, the NV items may be lost or have an error due to any of various possible reasons. When the NV items are lost or have an error, a booting process or an operation process of the portable terminal may not be performed normally and a malfunction may occur.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for shortening a booting time of a portable terminal.

Another aspect of the present invention is to provide an apparatus and a method for backing up Non-Volatile (NV) items in order to shorten a booting time of a portable terminal.

An additional aspect of the present invention is to provide an apparatus and a method for backing up only required NV items from NV items inside a file system of a portable terminal.

Still another aspect of the present invention is to provide an apparatus and a method for retrieving and using backed-up NV items during a booting process in a portable terminal.

Yet another aspect of the present invention is to provide an apparatus and a method for shortening a booting time by using backed-up data instead of using data inside a file system to reduce an access time in a process of retrieving NV items.

In accordance with an aspect of the present invention, an apparatus for shortening a booting time in a portable terminal is provided. The apparatus includes a memory for storing a file system including NV items including parameters used for driving and initializing a portable terminal, and a controller for generating and storing a calibration table representing transmission/reception performance values for at least one frequency band supported by the portable terminal from the NV items, and for copying the stored calibration table during a booting process of the portable terminal.

In accordance with another aspect of the present invention, a method for shortening a booting time in a portable terminal is provided. The method includes generating a calibration table representing transmission/reception performance values for at least one frequency band supported by the portable terminal from NV items inside a file system, storing the generated calibration table, and copying the stored calibration table during a booting process of the portable terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description when taken in conjunction with the accompanying drawings, in which:

FIG. 1 is a diagram illustrating a process of using Non-Volatile NV items in a conventional portable terminal;

FIG. 2 is a diagram illustrating a construction of a portable terminal according to an exemplary embodiment of the present invention;

FIG. 3 is a flow diagram illustrating a process of calibrating NV items in a portable terminal according to an exemplary embodiment of the present invention;

FIG. 4 is a flow diagram illustrating a booting process of a portable terminal according to an exemplary embodiment of the present invention; and

FIG. 5 is a diagram illustrating a process of processing NV items in a portable terminal according to an exemplary embodiment of the present invention.

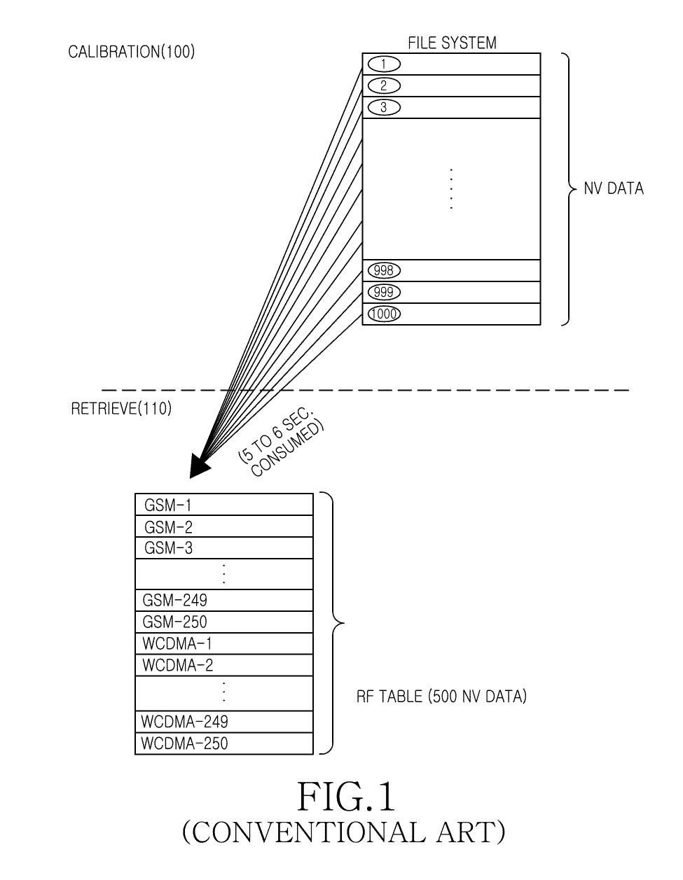

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an apparatus and a method for retrieving Non-Volatile (NV) items of a portable terminal in order to shorten a booting time of the portable terminal. In the following description, an RF table, which includes NV items for frequency bands supported by the portable terminal, is referred to as a calibration table. The RF table, which includes NV items for frequency bands supported by the portable terminal that is included in the calibration table, may include NV items for any combination of any number of frequency bands supported by the portable terminal.

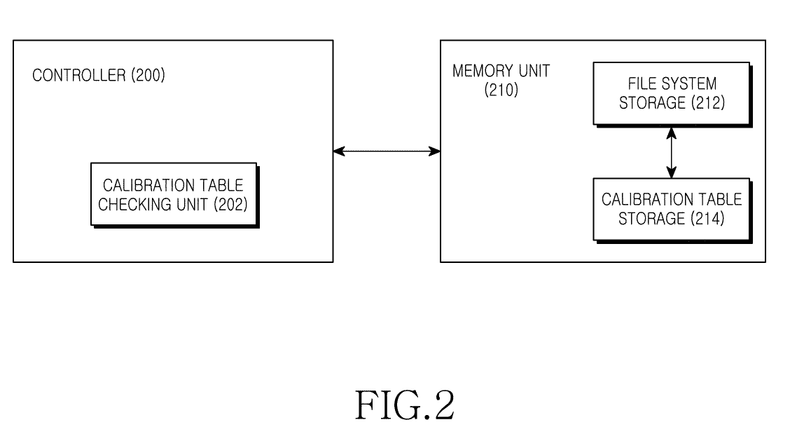

FIG. 2 is a diagram illustrating a construction of a portable terminal according to an exemplary embodiment of the present invention.

Referring to FIG. 2, the portable terminal includes a controller 200 and a memory unit 210. The controller 200 includes a calibration table checking unit 202.

The controller 200 of the portable terminal controls overall operations of the portable terminal. For example, the controller 200 performs processes and controls voice and data communications. In addition to general functions, according to an exemplary embodiment of the present invention, the controller 200 retrieves the calibration table that was stored in the memory unit 210 in advance, that is, NV items including transmission/reception performance values for frequency bands supported by the portable terminal during a booting process of the portable terminal.

The calibration table checking unit 202 of the controller 200 receives one or more instructions from the controller 200 during the booting process and copies the calibration table stored in the memory unit 210 to Random Access Memory (RAM). Here, the calibration table includes transmission/reception performance values, which are NV items for frequency bands supported by the portable terminal among NV items included in a file system.

The memory unit 210 includes a file system storage 212 for storing NV items that define unique information of the portable terminal and parameters required for driving and initializing the portable terminal such as set data of units performing respective functions, and a calibration table storage 214 for storing a calibration table which includes NV items for the frequency bands supported by the portable terminal among the NV items included in a file system.

Here, the file system storage 212 and the calibration table storage 214 may be provided as non-volatile memories in order to prevent data loss due to a discontinuation of power supplied to the portable terminal.

The function of the calibration table checking unit 202 may be performed by the controller 200 of the portable terminal. The calibration table checking unit 202 is provided as a separate element in an exemplary embodiment of the present invention, and not for the purpose of limiting the scope of the present invention. It would be obvious to those of ordinary skill in the art that various modifications can be made within the scope of the present invention. For example, the controller 200 may be configured to process any combination of any number of the functions described herein.

In the above description, an apparatus for retrieving NV items of a portable terminal in order to shorten a booting time of the portable terminal has been described. Hereinafter, exemplary embodiments of the present invention provide a method for shortening a booting time by separately storing a calibration table including NV items for frequency bands supported by a portable terminal, and retrieving the stored NV items whenever a booting process is performed in the portable terminal.

Before an operation of the portable terminal according to an exemplary embodiment of the present invention is described, an NV item calibration process of storing NV item values of the portable terminal in a non-volatile memory in order to optimize the performance of the portable terminal, and a booting process of driving the portable terminal using the NV items stored in the non-volatile memory, are described.

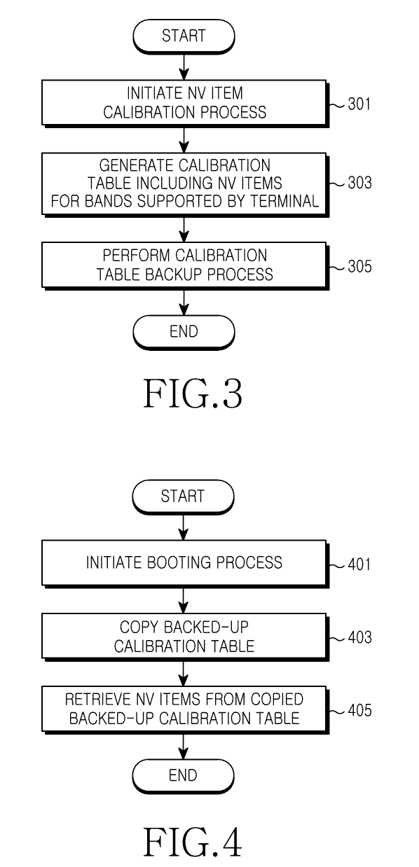

FIG. 3 is a flow diagram illustrating a process of calibrating NV items in a portable terminal according to an exemplary embodiment of the present invention. Here, the NV item calibration process of the portable terminal is a process of storing NV item values of the portable terminal in the file system storage 212, which is a non-volatile memory, in order to optimize the performance of the portable terminal.

Referring to FIG. 3, in step 301, the portable terminal initiates an NV item calibration process. In step 303, the portable terminal determines which NV items among the NV items in the file system correspond to frequency bands supported by the portable terminal and generates a calibration table including the NV items determined to correspond to the frequency bands supported by the portable terminal. Here, the calibration table includes transmission/reception performance values for the frequency bands supported by the portable terminal among the NV items included in the file system.

In step 305, the portable terminal stores the generated calibration table in the calibration table storage 214, which is a non-volatile memory such as a flash memory. Here, the portable terminal retrieves the calibration table from RAM and stores the retrieved calibration table in the calibration table storage 214, which is a non-volatile memory such as a flash memory. Here, the NV item calibration process of the portable terminal according to an exemplary embodiment of the present invention is similar to that of a conventional portable terminal in that both portable terminals have NV items stored in a file system in a non-volatile memory and both portable terminals generate a calibration table including NV items among NV items in the file system that are determined to correspond to frequency bands supported by the portable terminal. However, the portable terminal according to an exemplary embodiment of the present invention additionally performs a process of backing up the generated calibration table to a non-volatile memory such as a flash memory.

The portable terminal then ends the present algorithm.

FIG. 4 is a flow diagram illustrating a booting process of a portable terminal according to an exemplary embodiment of the present invention. Here, the booting process of the portable terminal includes a process of initializing and driving the portable terminal using NV items.

Referring to FIG. 4, in step 401, the portable terminal initiates a booting process. Here, the booting process is a process of making the portable terminal operable using NV items that have been stored in advance.

In step 403, the portable terminal copies to memory a calibration table of the NV items stored in advance in the calibration table storage 214, that is, the backed-up calibration table. In step 405, the portable terminal retrieves the NV items from the copied calibration table in the memory. Here, the portable terminal can shorten an access time to NV items to be used by copying the backed-up calibration table to RAM. In other words, unlike a conventional method, which retrieves NV items to be used from a file system whenever a booting process is performed, the portable terminal according to an exemplary embodiment of the present invention shortens a time consumed for accessing NV items to be used to improve performance compared to the conventional method. The portable terminal according to an exemplary embodiment of the present invention shortens a time consumed for accessing NV items by separately backing up the NV items among NV items in a file system that have been determined to correspond to the frequency bands supported by the portable terminal, and then retrieving the NV items from RAM which have been copied thereto from the backed-up NV items whenever a booting process is performed.

Here, the NV items are stored in a flash memory, copied to RAM, and then retrieved from RAM in order to prevent a loss of the NV items stored in the RAM due to a discontinuation of the supply of power to the portable terminal.

The portable terminal then ends the present algorithm.

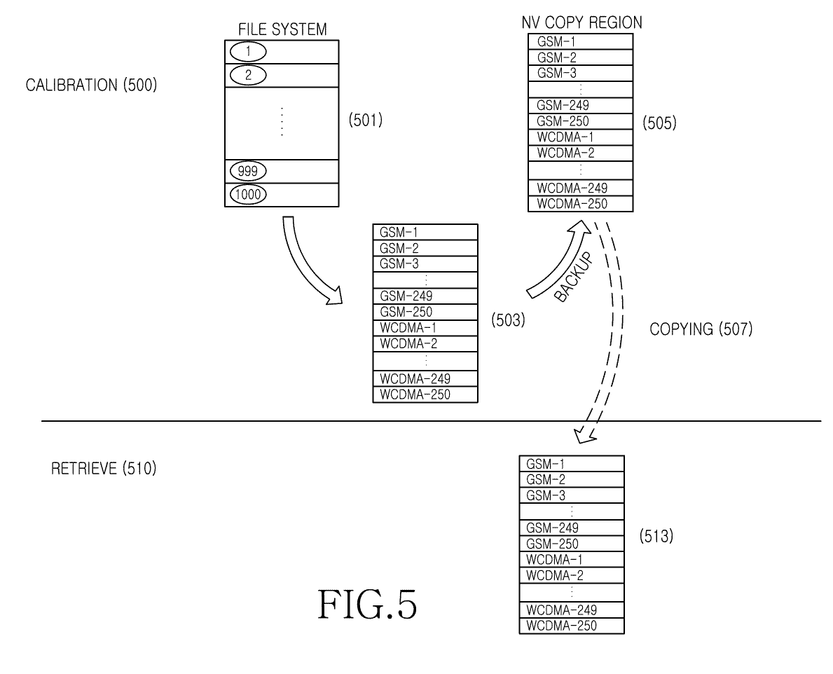

FIG. 5 is a diagram illustrating a process of processing NV items in a portable terminal according to an exemplary embodiment of the present invention.

In FIG. 5, an NV item calibration process of the portable terminal and a retrieve process of the portable terminal using NV items stored in a non-volatile memory are simultaneously illustrated.

The NV item calibration process 500 of the portable terminal is described with reference to FIG. 5. First, it is assumed that 1000 NV items, denoted by 501 in FIG. 5, are included in a file system of the portable terminal, and that there are 500 NV items (250 items related to GSM and 250 items related to WCDMA) corresponding to frequency bands supported by the portable terminal, denoted by 503 in FIG. 5, among 1000 NV items in the file system. Here, the 500 NV items corresponding to frequency bands supported by the portable terminal are referred to as a calibration table.

Accordingly, to perform the NV item calibration process, the portable terminal generates the calibration table 503, which includes the 500 NV items from the 1000 NV items in the file system. The 500 NV items include RF performance values for transmission/reception in WCDMA and GSM frequency bands that are supported by the portable terminal supporting WCDMA and GSM schemes.

The portable terminal completes the NV item calibration process by performing a backup process 505 of storing the calibration table which includes the above-defined 500 NV items in an NV item copy region of the non-volatile memory.

In the case where the portable terminal performs a retrieve process 510, the portable terminal performs the retrieve process by copying 507 the NV items backed-up (505) during the NV item calibration process 500 to a memory such as a RAM. The copied and backed-up calibration table is denoted by 513 in FIG. 5.

Unlike the conventional method, the above-described method can improve a booting speed.

In other words, the conventional portable terminal accesses a file system, checks each data with respect to NV items inside the file system, generates a subset of the NV items inside the file system that correspond to frequency bands supported by the portable terminal, and performs a process of retrieving the NV items corresponding to the frequency bands supported by the portable terminal whenever a booting process is performed. Typically, a booting time of about 5 to 6 seconds is required to access the file system, check the NV items, and generate the subset of NV items inside the file system that correspond to frequency bands supported by the portable terminal.

On the other hand, the portable terminal according to an exemplary embodiment of the present invention shortens a booting time of the portable terminal, by quickly retrieving a calibration table, and can operate normally when NV items have an error or are lost. To do so, the portable terminal according to an exemplary embodiment of the present invention performs an NV item calibration process of storing, that is, backing up, in a non-volatile memory, the calibration table which includes NV items corresponding to frequency bands supported by the portable terminal among NV items in the file system, by copying the calibration table stored in the non-volatile memory to RAM, and by using the copied calibration table, whenever a booting process is performed.

As described above, exemplary embodiments of the present invention provide an apparatus and a method for retrieving NV items in the portable terminal. NV items for frequency bands supported by the portable terminal are collected and stored separately, and then the stored NV items are retrieved whenever a booting process is performed, so that a time consumed for accessing NV items corresponding to frequency bands supported by the portable terminal is shortened, and consequently, a booting time of the portable terminal is shortened. The NV items are quickly retrieved when the NV items have an error or are lost, so that the portable terminal can operate normally.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for retrieving Non-Volatile (NV) items in a portable terminal, the apparatus comprising:
a memory for storing a file system comprising NV items comprising parameters used for driving and initializing a portable terminal; and
a controller for generating and storing a calibration table representing transmission/reception performance values for at least one frequency band supported by the portable terminal from the NV items, and for copying the stored calibration table during a booting process of the portable terminal.

2. The apparatus of claim 1, wherein the controller copies the stored calibration table to Random Access Memory (RAM).

3. The apparatus of claim 2, wherein the controller uses the copied stored calibration table in RAM during the booting process of the portable terminal.

4. The apparatus of claim 1, wherein the NV items comprise at least one of unique information of the portable terminal, set data of units used for performing functions of the portable terminal, and parameters required for driving and initializing the portable terminal.

5. The apparatus of claim 1, wherein the controller generates the calibration table from the NV items inside the file system.

6. The apparatus of claim 5, wherein the controller stores the calibration table in a non-volatile memory.

7. The apparatus of claim 1, wherein the calibration table comprises NV items, from among the NV items comprised by the file system, that represent the transmission/reception performance values for the at least one frequency band supported by the portable terminal.

8. The apparatus of claim 1, wherein the controller generates the calibration table by determining which of the NV items comprised by the file system represent the transmission/reception performance values for the at least one frequency band supported by the portable terminal.

9. The apparatus of claim 1, wherein the calibration table represents transmission/reception performance values for each frequency band supported by the portable terminal.

10. A method for retrieving Non-Volatile (NV) items in a portable terminal, the method comprising:
generating a calibration table representing transmission/reception performance values for at least one frequency band supported by the portable terminal from NV items inside a file system;
storing the generated calibration table; and
copying the stored calibration table during a booting process of the portable terminal.

11. The method of claim 10, wherein the copying of the stored calibration table comprises copying the stored calibration table to Random Access Memory (RAM).

12. The method of claim 11, further comprising using the copied stored calibration table in RAM during the booting process of the portable terminal.

13. The method of claim 10, wherein the NV items inside the file system comprise at least one of unique information of the portable terminal, set data of units used for performing functions of the portable terminal, and parameters required for driving and initializing the portable terminal.

14. The method of claim 10, wherein the generating of the calibration table comprises determining which of the NV items in the file system represent the transmission/reception performance values for the at least one frequency band supported by the portable terminal.

15. The method of claim 14, wherein the storing of the calibration table comprises storing the calibration table in a non-volatile memory.

16. The method of claim 10, wherein the calibration table comprises NV items, from among the NV items comprised by the file system, that represent the transmission/reception performance values for the at least one frequency band supported by the portable terminal.

17. The method of claim 10, wherein the calibration table represents transmission/reception performance values for each frequency band supported by the portable terminal.

18. A method for retrieving Non-Volatile (NV) items in a portable terminal, the method comprising:
storing, in a first non-volatile memory, NV items in a file system, each NV item representing one or more transmission/reception performance values corresponding to a frequency bands;
determining which of the NV items in the file system represent transmission/reception performance values corresponding to frequency bands supported by a portable terminal;
generating a calibration table comprising the NV items in the file system determined to represent transmission/reception performance values corresponding to the frequency bands supported by the portable terminal;
storing, in a second non-volatile memory, the calibration table;
during a booting process of the portable terminal, copying the calibration table from the second non-volatile memory to Random Access Memory (RAM); and
using the calibration table in RAM during the booting process of the portable terminal.

19. The method of claim 18, wherein the first non-volatile memory and the second non-volatile memory are different storage areas a non-volatile memory.
